(19) United States
(12) Patent Application Publication
(10) Pub. No.: US 2019/0331330 A1
(43) Pub. Date: Oct. 31, 2019

(54) SYSTEMS AND METHODS FOR CONTROLLING THE OUTPUT OF ONE OR MORE LIGHT-EMITTING DEVICES

(71) Applicants: Chia Ming CHEN, Cambridge, MA (US); Huikai XIE, Gainsville, FL (US)

(72) Inventors: Chia Ming CHEN, Cambridge, MA (US); Huikai XIE, Gainsville, FL (US)

(21) Appl. No.: 16/310,069

(22) PCT Filed: Jun. 30, 2017
(86) PCT No.: PCT/US17/40172

§ 371 Date: Dec. 14, 2018

Related U.S. Application Data
(60) Provisional application No. 62/357,350, filed on Jun. 30, 2016.
(60) Provisional application No. 62/410,134, filed on Oct. 19, 2016.
(60) Provisional application No. 62/439,000, filed on Dec. 24, 2016.
(60) Provisional application No. 62/513,397, filed on May 31, 2017.

(51) Int. Cl. F21V 23/04; F21V 14/02; F21V 14/06; F21V 5/00; F21V 5/04; G01J 5/00; G01V 8/10; G01S 17/66

(52) U.S. Cl. CPC F21V 23/0471; F21V 14/02; F21V 14/06; F21V 5/007; F21Y 2115/10; G01J 5/0025; G01V 8/10; G01S 17/66; F21V 5/045

(57) ABSTRACT

Provided is a tracking light system that tracks one or more targets and provides an illumination region locally at the one or more targets, comprising: a tracking light module, comprising: a sensor module array comprising a plurality of sensor modules, each sensor module comprising at least one sensor; an light emitting diode (LED) module array comprising a plurality of LED modules; and a lens in front of the LED module array, wherein an LED of an LED module of the LED module array outputs a source of light directed at the lens and forming a projection spot on a surface of an area of interest, the at least one sensor forming a detection region that overlaps the projection spot for monitoring the projection spot. When an object is detected in the detection region, the LED is activated to output the source of light. When the object departs the detection region, the LED is turned off.

### RELATED APPLICATIONS

This application claims the benefit of U.S. Provisional Patent Application No. 62/357,350 filed on Jun. 30, 2016, U.S. Provisional Patent Application No. 62/410,134 filed on Oct. 19, 2016, U.S. Provisional Patent Application No. 62/439,000 filed on Dec. 24, 2016, and U.S. Provisional Patent Application No. 62/513,397 filed on May 31, 2017, the content of each of which is incorporated herein by reference in its entirety.

This application is related to International Patent Application Number PCT/US2015/028163 filed on Apr. 29, 2015, U.S. Non-provisional application Ser. No. 13/826,177 filed on Mar. 14, 2013, U.S. and International Application Number PCT/US2014/044643 filed on Jun. 27, 2014, the content of each of which is incorporated herein by reference in its entirety.

### TECHNICAL FIELD

The present inventive concepts generally relate to the field of light-emitting devices, and more particularly, to systems and methods for employing and controlling the output of one or more light-emitting devices.

### BACKGROUND

Modern occupation sensors are employed to control lighting so that the source of light is on only when users are present in the field of view of the sensors. However, the sensors are based on motion or sound-based sensing. Both have low resolutions. When sensing a user, not only are lights near the user turned on, but lights far away from the user are also turned on, resulting in a waste of energy.

### SUMMARY

The present inventive concepts address the foregoing conventional issue.

In some embodiments, a tracking light system includes arrays of sensor modules to detect presence of a target at an intended area. The sensor module arrays may divide the area into sub-regions. Each sub-region, referred to as a detection region, is monitored in real time by a sensor module. In some embodiments, each sensor module provides for a non-overlapping region of detection with its neighbors. In some embodiments, each sensor module provides for over-lapping regions of detection with its neighbors. The same number of LED modules are used to illuminate regions of detection for all sensor modules in some embodiments. Each sensor module may be assigned to at least one LED module. The lines of sight (LOS) of this sensor-LED pair may align or nearly align. The detection region of the sensor module and the illumination area of the corresponding LED module overlap. In some embodiments, whenever a target or targets are detected in a detection region of a sensor module, the corresponding LED module is turned on. In some embodiments when the target moves to a detection region of the adjacent sensor module, its corresponding LED module is activated, i.e., power is applied to turn the LED module on. A previous LED module is turned off. When the target is in the detection region, the sensor outputs an electronic signal that instructs the LED module to illuminate the target. Here, the LED module is activated. When the target departs the detection region, the sensor outputs an electronic signal that instructs LED module to turn off the light. Because each sensor-LED pair is only responsible for sensing and illumination for its own small region, lighting control can be performed locally in each detection region. A high resolution localized illumination can be produced by LEDs. Because the intended area is covered by the detection/illumination areas of arrays of sensor-LED pairs, a high resolution localized illumination is available everywhere at the same time. Each sensor/LED pair can illuminate its own detection region independently, multiple or even all sensor/LED pairs can illuminate their areas at the same time. In some embodiments, multiple users can use localized illuminations in multiple places at the same time.

In some embodiments, fixed directions of an LED illumination of a LED module array can be obtained by placing a Fresnel lens in front of the LED module array. A fixed position of an LED in turn produces a fixed illumination beam direction. Their directions are determined by their fixed relative positions of individual LED modules and the Fresnel lens center. Each LED module is assigned to a sensor module whose line of sight (LOS) aligns or nearly aligns to that of the LED module. LED modules are only turned on when targets are in their corresponding sensor detection regions. They are turned off once the targets leave their corresponding sensor detection regions. The on/off switches can be operated instantly. This ensures high speed tracking illumination. In some embodiments, a sensor module can be placed on a gimbal or the like. The view direction of the sensor module can be obtained by rotating the gimbal or the like. In some embodiments, other beam steering mechanisms such as MEMS mirror can be used to direct the sensor LOS to that of the corresponding LED module.

In some embodiments, a single moving LED module light source is used to replace the LED module array behind a Fresnel lens. The moving LED module moves laterally to various positions behind the Fresnel lens at the tracking light module to illuminate various detection regions in which a target or is detected. When the target moves to sensor detection regions belonging to another tracking light module, the moving LED module in that module turns on and continue to track the target. The moving LED module in the previous tracking light module is inactivated, or turned off.

In some embodiments, a steerable sensor and a steerable light can be used to form a steerable tracking light module. An example of a steerable light is described in PCT patent application PCT/US2015/028163, the contents of which are incorporated herein by reference in their entirety. A steerable sensor may be a sensor with a beam steering mechanism that steers the FOV of the sensor, but not limited thereto. The steerable tracking light tracks the target and steers light beam to follow the target. When multiple steerable tracking light modules are installed on a ceiling or other surface, it can continuously track a target and steer a light beam to follow the target over a large range.

In some embodiments, a lens array can be placed in front of a LED array. Each LED faces its own lens. The beams from all LED overlap. There are some non-overlap regions caused by the offsets among the LEDs. The intensity in the resulting beam is the sum intensity from all LEDs. In some embodiments, the lens array can be placed on a xy planar motion platform to perform beam steering. Beam steering is obtained by relative translation motion between the LED array and the lens array. In some embodiments, the LED array can be placed on a 2 dimensional, e.g., xy planar, motion platform to perform a beam steering operation.

In some embodiments, an LED array can comprise of red, green, and blue (RGB) LEDs. By mixing the intensity levels of various RGB LEDs, different colors for illumination can be obtained. In some embodiments, either the LED array or the lens array can be placed on a xy planar motion platform for beam steering. Color mixing light beam therefore can be moved to anywhere for users.

In some embodiments, an LED array mentioned above can comprise at least one of LiFi communication LEDs or visible LEDs. The output light beam from this optical arrangement can be used for illumination and LiFi communications at the same time. In some embodiments, either the LED array or the lens array can be placed on an xy planar motion platform for beam steering, i.e., directing the output light beam at a position of interest. Users can access illumination and LiFi communications at the same time at a predetermined location.

In some embodiments, the LED array mentioned above can comprise LEDs at various color temperatures, e.g., warm, neutral, and cool. By tuning the intensity levels of various color temperature LEDs, different color temperature illuminations can be obtained. In some embodiments, either the LED array or the lens array can be placed on an xy planar motion platform for beam steering. A color temperature tuned light beam therefore can be directed at a location of interest to the user.

In some embodiments, RGB LEDs can be placed at the three foci of a 3-face pyramid mirror lens assembly. Because the LEDs share the same lens, their output light beams overlap, and preferably overlap completely. Color mixing can be obtained by varying the input of the RGB inputs. The color mixing light beam can be directed, i.e., beam steered using a beam steering mechanism or the like, by moving the lens laterally relative to the LEDs in some embodiment. By moving the lens toward or away from the LED array, the size of the color light beam can be adjusted.

In some embodiments, warm, neutral, and cool LEDs can be placed at the three foci of a 3-face pyramid mirror lens assembly. Because the LEDs share the same lens, their output light beams overlap, and preferably overlap completely. Color temperature tuning can be obtained by varying the inputs of the 3-color temperature LEDs. The resulting light beam can be beam steered by moving the lens laterally relative to the LEDs in some embodiment.

In some embodiments, a LiFi communication light source, two illumination light sources can be placed at three foci of a 3-face pyramid lens assembly. Because the LEDs share the same lens, their output light beams overlap, and preferably overlap completely. Users can access illumination features and ultra-high speed data communication network, e.g., internet, at the same time. The resulting light beam can be beam steered by moving the lens laterally relative to the LEDs in some embodiments.

The white LED spectral of the warm, neutral, and cool color temperatures do not match the blackbody spectral at the corresponding color temperatures. Thus, in some embodiments, multiple color LEDs can be used to create output light whose spectrum closely matches to blackbody spectrum. To achieve that, multiple color LEDs can be placed at the foci of a multi-facet pyramid mirror lens assembly in some embodiments. Because the LEDs share the same lens, their output light beams overlap, preferably overlap completely. By varying the inputs of the color LEDs, blackbody spectral at various blackbody temperatures can be created in some embodiments. The resulting light beam can be directed, for example, using a beam steering mechanism or the like, by moving the lens laterally relative to the LEDs in some embodiments.

The effective focal length of a 2-lens system can be adjusted according to the spacing between the two lenses. In some embodiments, a 2-lens system with spacing adjustment devices can be used to operate a steerable light source. When it replaces the fixed focal length lens of a steerable light source, the steerable light source has the ability to steer a light beam at various focal lengths. Users can steer a light beam produced by the light source to a large range at short focal length, 20 mm for example. Alternatively, users can have small high intensity light beam at the expense of shorter beam steering range for long focal length, 120 mm for example.

In another aspect, provided is a tracking light system that tracks one or more targets and provides an illumination region locally at the one or more targets, comprising: a tracking light module, comprising: a sensor module array comprising a plurality of sensor modules, each sensor module comprising at least one sensor; an light emitting diode (LED) module array comprising a plurality of LED modules; and a lens in front of the LED module array, wherein an LED of an LED module of the LED module array outputs a source of light directed at the lens and forming a projection spot on a surface of an area of interest, the at least one sensor forming a detection region that overlaps the projection spot for monitoring the projection spot, wherein when an object is detected in the detection region, the LED is activated to output the source of light, and wherein when the object departs the detection region, the LED is turned off.

In some embodiments, the object is a target user.

In some embodiments, the at least one sensor of the at least one sensor module comprises an emissive thermal sensor and a single band or multispectral reflective sensor.

In some embodiments, the sensor module comprises a thermal sensor, a visible/IR sensor, and a beamsplitter, wherein the thermal sensor senses thermal signal from the object, the visible/IR sensor uses the target reflected light from the visible and IR LEDs for single band monochromatic imaging or multiband for multispectral imaging, the thermal sensor uses thermal signal to detect the object, the visible/IR sensor uses color, motion, and human feature as well as hand.

In some embodiments, the LED of the LED module comprises a visible light LED, IR light LED, and a hot mirror that provides visible light for illumination of the projection spot, IR light, and visible light for multispectral or monochromatic imaging.

In some embodiments, the tracking light system further comprises a beam steering mechanisms for steering the sensor to direct a field of view (FOV) of the sensor.

In some embodiments, the beam steering mechanism includes at least one of a gimbal, MEMS mirrors, Risley prism pair, or moving lens.

In some embodiments, the LED module array includes a moving LED module that moves to the positions of the LED modules of the LED module array in the tracking light module, for single target tracking illumination.

In some embodiments, the tracking light modules are steerable for continuously tracking the object and steering the output source of light to follow the object.

In another aspect, provided is a light beam steering and light beam size adjustment lighting device, comprising: a lens array; a light emitting diode (LED) array; and a motion platform, wherein the lens array is place directly in front of the LED array such that each individual LED of the LED array faces one lens of the lens array to produce an overlapping light beam having an intensity that is the sum intensities from all LEDs in the LED array.

In some embodiments, either the LED array or the lens array is positioned on the motion platform to produce a relative planar motion for steering the output the light beam.

In some embodiments, the light beam steering and light beam size adjustment lighting device further comprises a set of motorized vertical rails to move the motion platform such that the lens array and LED array moves toward or away from each other for adjusting the size of the output light beam.

In some embodiments, the motion platform is an electromagnetic type describe or a motorized rail type.

In some embodiments, the lighting device is operable for a light beam steerable, light beam size adjustable, color mixing lighting device, wherein the LED array includes a color LED array comprising groups of RGB LEDs.

In some embodiments, the lighting device is operable for a light beam steerable, light beam size adjustable, LiFi communication and illumination lighting, wherein the LED array includes a LiFi communication light source and visible LEDs for illumination.

In some embodiments, the lighting device is operable for a light beam steerable, light beam size adjustable, color temperature tunable lighting device, wherein the LED array includes groups of LEDs with warm, neutral, and cool color temperatures.

In another aspect, provided is a LED color light mixing optical system with beam steering and beam size adjustment capability, comprising a lens; a 3-face pyramid mirror; and three color LEDs at a foci of the lens to produce a color light beam fully overlapping in space, wherein the 3-face pyramid mirror is at the focusing beam path of the lens to produce three foci for placing the RGB LEDs, wherein the input currents of the RGB LEDs are adjusted to produce various color light beams.

In some embodiments, the LED color light mixing optical system further comprises a motion platform that moves the lens laterally respect to the pyramid mirror and RGB LEDs for steering the output color light beam, the motion platform that moves the lens toward or away from the pyramid mirror and LEDs to change the size of the output color light beam.

In some embodiments, an optical system can be used to produce a steerable, beam size adjustable, light beam for both illumination and LiFi communications by replacing the RGB LEDs by LiFi communication and visible LEDs.

In some embodiments, an optical system can be used to produce a steerable, beam size adjustable, color temperature adjustable light beam by replacing the RGB LEDs with LEDs at warm, neutral, and cool color temperatures.

A two-lens system with adjustable gap between two lenses allowing the focal length to be adjustable for steering light beam and adjusting the light beam size in a steerable light or device in accordance with some embodiments herein in combination with PCT/US2015/028163 incorporated by reference herein.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same elements throughout the different views. The drawings are not necessarily to scale, emphasis instead being placed upon illustrating the principles of the preferred embodiments.

FIG. 1 is a drawing illustrating the beam pattern of a light source array through a Fresnel lens, in accordance with some embodiments.

FIG. 2 is a drawing illustrating the automatic tracking light module, in accordance with some embodiments.

FIG. 3A is a drawing of the light source module for an automatic tracking light module, in accordance with some embodiments.

FIG. 3B is a drawing of a sensor module for an automatic tracking light module, in accordance with some embodiments.

FIG. 4A is a drawing of a gimbal for adjusting the sensor line of sight (LOS), in accordance with some embodiments.

FIG. 4B is a drawing of a MEMS mirror for adjusting the sensor LOS of FIG. 4A.

FIG. 5 is a drawing illustrating a concept of an automatic tracking illumination, in accordance with some embodiments.

FIG. 6 is a concept of an automatic tracking illumination, in accordance with some embodiments.

FIG. 7 is the beam pattern generated by a light source array through a lens array, in accordance with some embodiments.

FIG. 8 is a drawing of a light source to a Fresnel lens array assembly, in accordance with some embodiments.

FIG. 9 is a concept of a beam steering using a light source to a Fresnel lens array module, in accordance with some embodiments.

FIG. 10 is a drawing of a motorized vertical rail system for beam size adjustment, in accordance with some embodiments.

FIG. 10A is a drawing of a motorized rail beam size adjustment mechanism, in accordance with some embodiments.

FIG. 10B is a drawing of an electromagnetic beam size adjustment mechanism, in accordance with some embodiments.

FIG. 11 is a drawing of a motorized rail beam steering mechanism, in accordance with some embodiments.

FIG. 12 is a concept of color mixing using LED to lens array assembly with beam steering capability, in accordance with some embodiments

FIG. 13 is a concept of co-LOS illumination and LiFi communication with beam steering capability, in accordance with some embodiments.

FIG. 14 is a concept of color temperature tuning using LED to lens array assembly with beam steering capability, in accordance with some embodiments.

FIG. 15A is a side view drawing a 3-face pyramid mirror to lens assembly for color mixing, in accordance with some embodiments.

FIG. 15B is a front view drawing a 3-face pyramid mirror to lens assembly for color mixing, in accordance with some embodiments.

FIG. 16A is a side view drawing of a 3-face pyramid mirror to lens assembly for co-LOS illumination and LiFi communications, in accordance with some embodiments.

FIG. 16B is a front view drawing of a 3-face pyramid mirror to lens assembly for co-LOS illumination and LiFi communications, in accordance with some embodiments.

FIG. 17A is side view drawing of a 3-face pyramid mirror to a lens assembly for color temperature tuning, in accordance with some embodiments.

FIG. 17B is top view drawing of a 3-face pyramid mirror to a lens assembly for color temperature tuning, in accordance with some embodiments.

FIG. 18 is a plot illustrating spectral for various color temperature LEDs, in accordance with some embodiments.

FIG. 19A is a plot of blackbody spectral at various temperatures, in accordance with some embodiments.

FIG. 19B is a plot illustrating spectral of various color LEDs, in accordance with some embodiments.

FIG. 20A is a side view drawing of a multi-facet pyramid mirror to lens assembly for color temperature tuning with beam steering capability, in accordance with some embodiments.

FIG. 20B is a front view drawing of a multi-facet pyramid mirror to lens assembly for color temperature tuning with beam steering capability, in accordance with some embodiments.

FIG. 21A is a plot of effective focal length adjustment using lens separation for a two-lens system, in accordance with some embodiments.

FIG. 21B is a side drawing of a motorized effective focal length adjustment for a two-lens system, in accordance with some embodiments.

FIG. 22 is a view of a holographic controller, in accordance with some embodiments.

FIG. 23 is a view of a beam steering mechanism, in accordance with some embodiments.

### DETAILED DESCRIPTION OF EMBODIMENTS

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

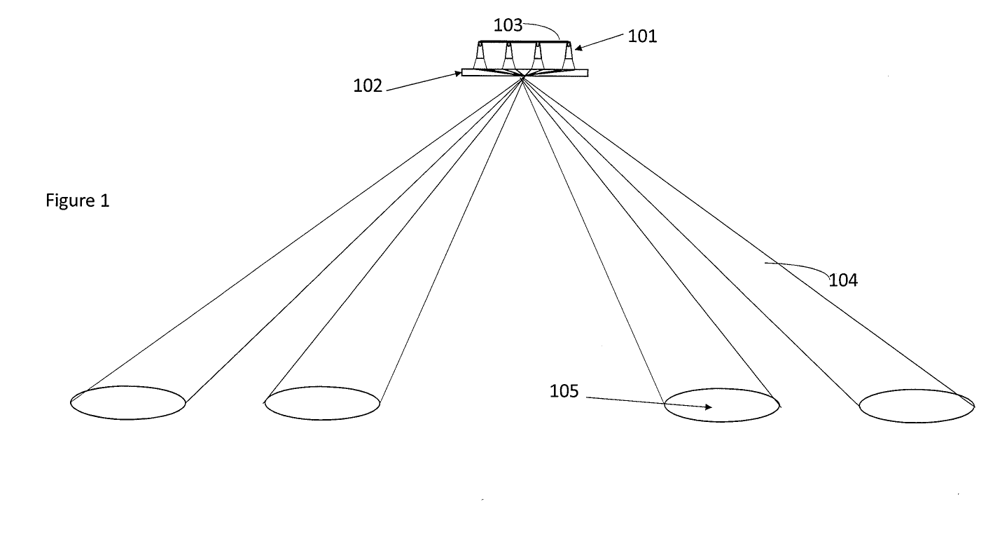

FIG. 1 illustrates the beam pattern of a LED module array 101 through a lens 102, in accordance with some embodiments. In some embodiments, the lens 102 can be a Fresnel lens. In some embodiments, the lens 102 can be other types of lens. It creates the illumination spots 105 in various directions according to the relative positions of the individual LED modules of the array 101 to a center region of the Fresnel lens 102. In some embodiments, the LED module array 102 is mounted to a heatsink 103. Each LED module in the array 102 may output through the lens 102 a light cone 104 at a specific direction. In some embodiments, a LED module array 101 and a lens 102 can be used to construct a light source array module.

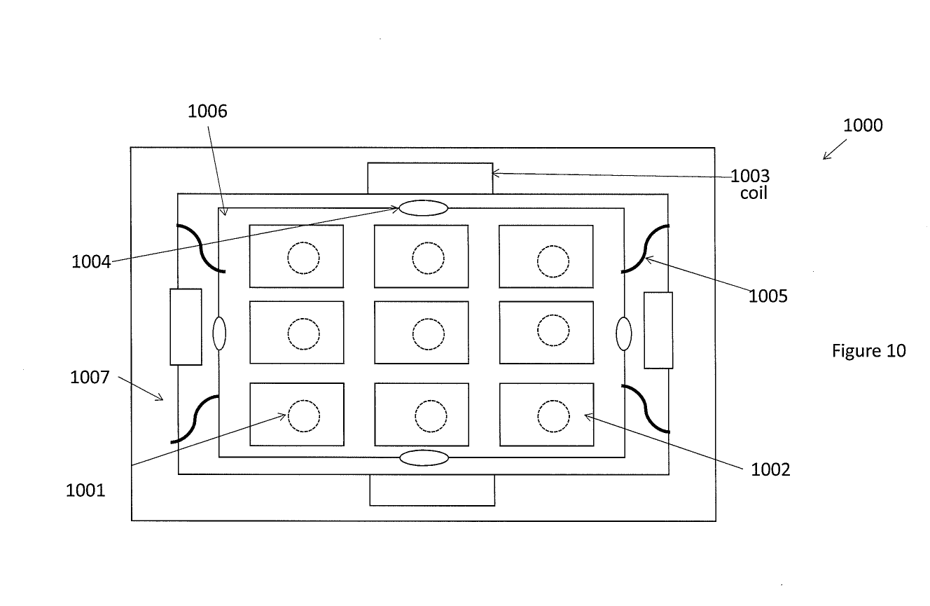

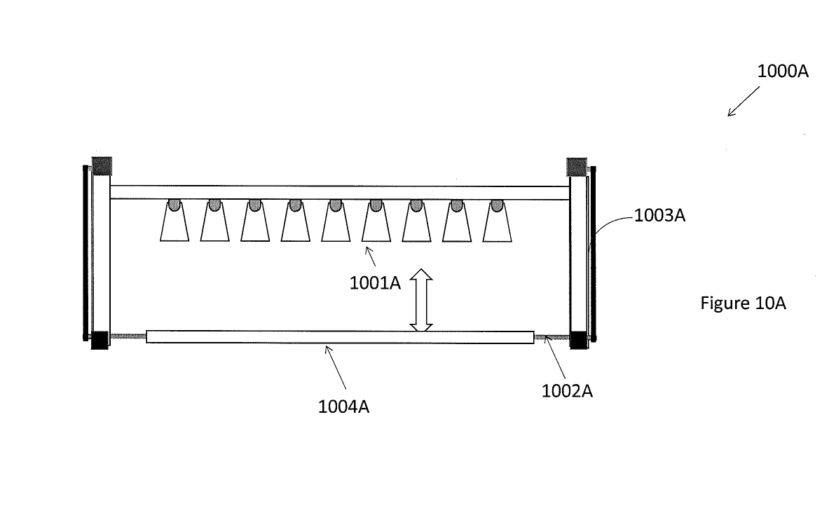

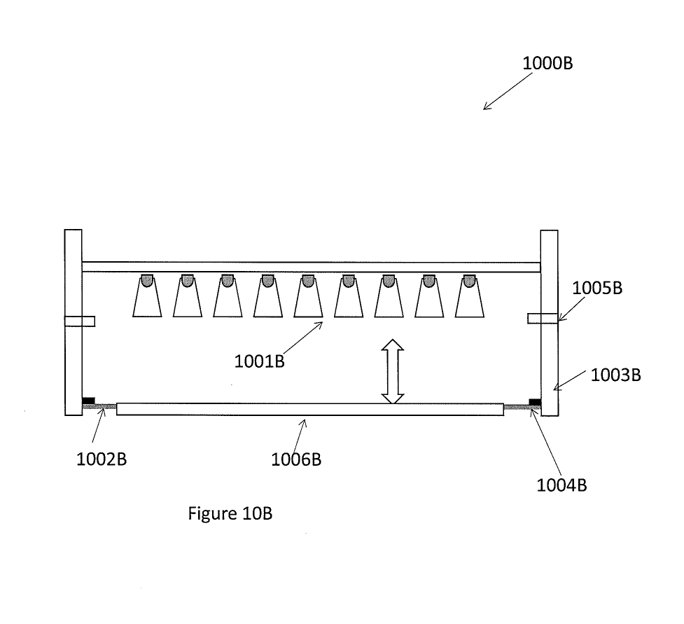

The LED module array 101 is placed behind the Fresnel lens 102 to generate array of illumination light cones at designated directions. At the illumination surface, an array of illumination spots 105 can be created. LED modules of the LED module array 101 can be turn on/off individually in some embodiments. In some embodiments, each LED module in the LED module array 101 has a fixed position relative to the center of the lens 102, for example, Fresnel lens. In some embodiments, each LED module in the LED module array can be mounted to a mini xy planar motion platform as illustrated in FIG. 10B. The electromagnetic motion platform in FIG. 10B can be make very small and fast. This allows small light beam motion around its fixed position. This will allow each illumination beam generated by the LED module array 101 to have a small motion around its regular position when the LED moves in this platform.

In some embodiments, each LED module can be assigned to a sensor module whose pointing direction nearly coincides with the LOS of the corresponding LED module. The field of view (FOV) of the sensor module overlaps the illumination light cone 104 of the corresponding LED module. The sensor module in general senses the presence of a target in its detection region and informs the LED module to turn on the light. When the target departs a detection region, sensor informs the LED module to turn off the light.

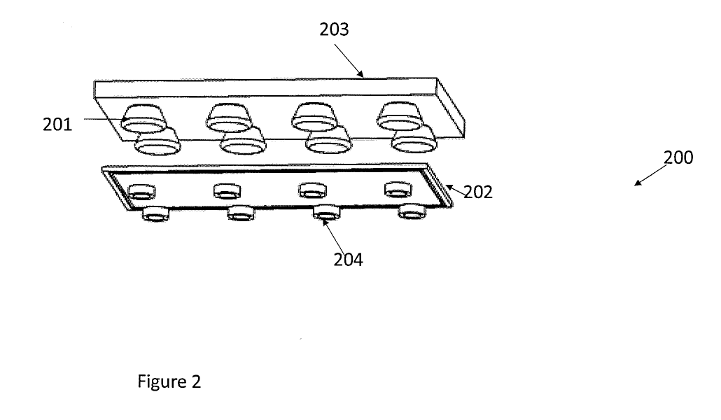

FIG. 2 is a drawing of a tracking light module 200. FIG. 2 distinguishes from FIG. 1 in that FIG. 1 illustrates only the illumination pattern of the LED module array from a tracking light module. FIG. 2, on the other hand, illustrates an embodiment of a tracking light module which include both LED module array and sensor module array, wherein the sensors in the tracking light module will automatically track targets. In some embodiments, the tracking light module 200 can comprise of a LED module array 201, Fresnel lens 202, sensor module array 204, and heat sink 203. In some embodiments, the sensor module array 204 can be placed directly below the Fresnel lens 202. In some embodiments, the LED module array 201 may be the same as or similar to LED module array 101 of FIG. 1. In some embodiments, the sensor module array 204 can be placed some where else. (The sensors may be attached to a piece of transparent material such as glass or acrylic and mounted below the LED module array 201.

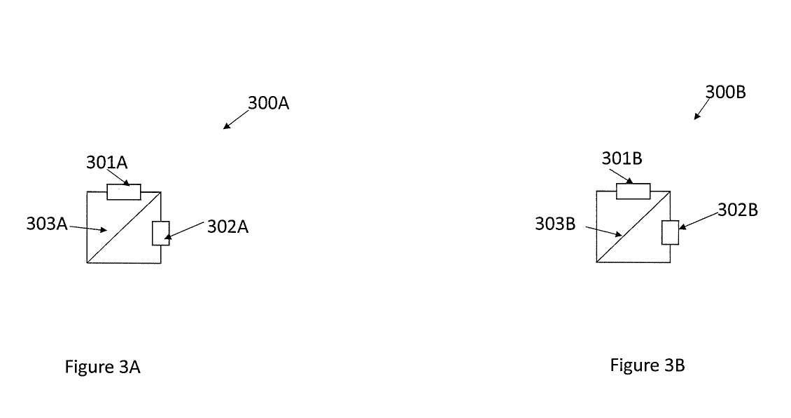

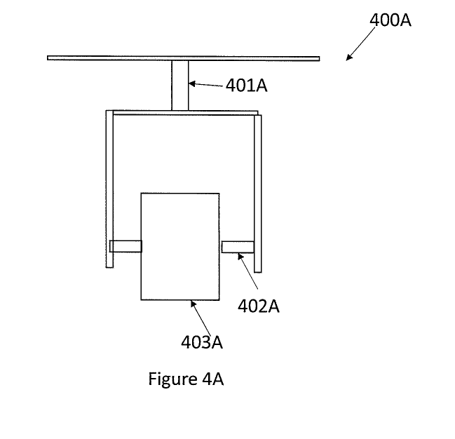

FIG. 3A illustrates the configuration of a LED light source module 300A of an LED module array, for example, LED module array 101 in FIG. 1 or LED module array 201 in FIG. 2. In some embodiments, each LED module 300A in the LED module array has only a visible LED. In some embodiments, each LED module 300A in the LED module array can comprise a visible LED 301A for illumination and an infrared (IR) LED 302A for target sensing. The visible LED 301A and the IR LED 302A are oriented 90° to each other with a hot mirror 303A separating them. The hot mirror is oriented at 45° or other relevant angle, and transmits visible light while reflecting IR light. In some embodiments, the IR LED is a near infrared (NIR) LED. In some embodiments, the IR LED is a shortwave infrared (SWIR) LED.

FIG. 3B illustrates the configuration of a sensor module 300B of a sensor module array, for example, sensor module array 204 of FIG. 2. In some embodiments, each sensor module 300B in the sensor array can comprise of an emissive thermal sensor 301B and a single band or multispectral reflective sensor 302B. Sensors 301B and 302B are separated by a beamsplitter 303B. The beamsplitter is oriented at 45° or other relevant angle relative to both sensors 301A, B. It transmits a thermal signal emitted by the target while reflects visible and IR light from the same target. In some embodiments, the thermal sensor 301B can be a single detector sensor. In other embodiments, the sensor 301B can be an imaging sensor. In some embodiments, the reflective sensor 302B can be a single detector sensor. In other embodiments, the visible/IR sensor can be an imaging sensor. In some embodiments, the visible/IR sensor 302B can be a single band sensor. In other embodiments, it can be a multispectral sensor using both visible and IR light. Both visible light and IR light can come from visible LED and IR LED in the LED module array in some embodiments.

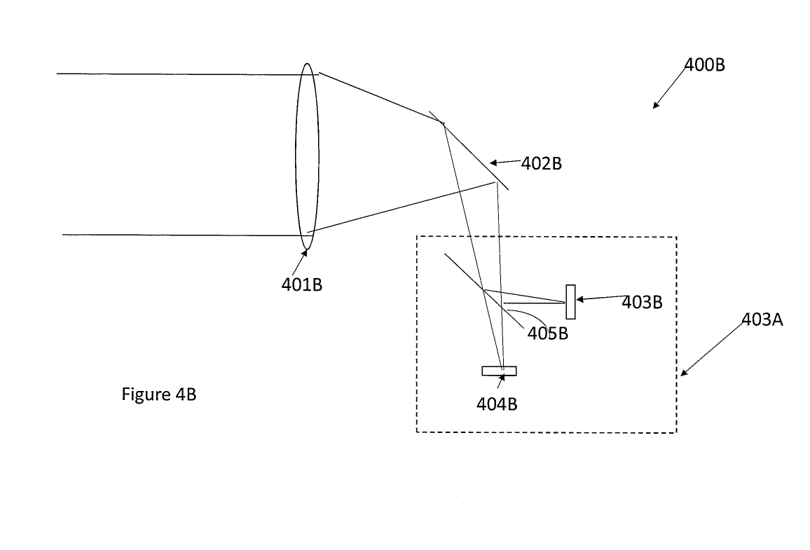

FIG. 4A illustrates a sensor gimbal 400A for adjusting a sensor pointing angle, in accordance with some embodiments. A sensor module 403A is mounted on the gimbal. Sensor module 403A may be similar to other sensor modules described herein. Therefore details are omitted due to brevity. The gimbal 400A has a roll axis 401A and a pitch axis 402A. The gimbal can direct a sensor FOV to its designated direction.

As shown in FIG. 4B, a MEMS mirror or MEMS mirror array 402B may be used to direct the FOV of the sensor module to its designated direction. The sensor module 403A includes both emissive thermal sensor 403B and visible/IR sensor 404B. Sensor 403A may be the same as in previous figures, so details are not repeated for brevity. As described herein, a beamsplitter 405B may be used to transmit thermal signal and reflect visible and IR signals from target. In this configuration, an imaging optics 401B may be used to collect signal light. The imaging optics transmits both thermal light and VIS/IR light. FIGS. 4A and 4B show only two beam steering mechanisms for adjusting the pointing angle of the sensor module 403A. In some embodiments, other beam steering mechanisms can be also used to steer the sensor FOV to its designated direction.

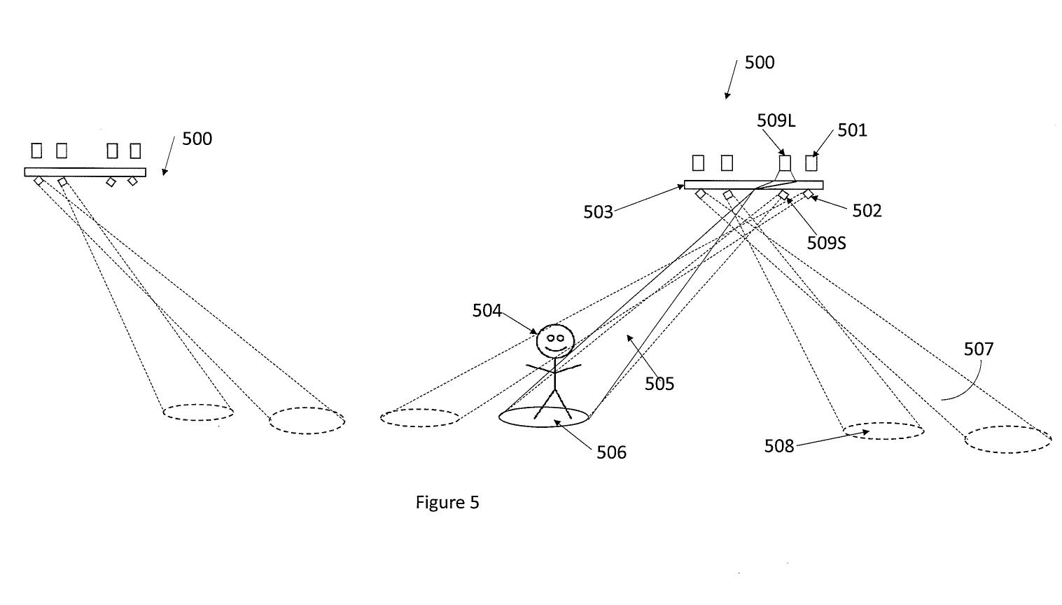

FIG. 5 illustrates a concept of tracking illumination. A plurality of tracking light modules 500 can be installed in the ceiling or other surfaces such that sensor FOVs 507 from all sensor arrays 502 of all tracking light modules 500 cover the whole area on the illumination surface in some embodiments. The area of interest is divided into sub-regions 508 each covered by the FOVs of individual sensor modules of the sensor arrays 502. Each sensor module is responsible for monitoring activities within its own sub-region also referred to as a detection region. In some embodiments, a detection region of a sensor module does not overlap the detection regions of its neighbors. In other embodiments, the detection area of a sensor module overlaps the detection regions of its neighbors. A sensor module relies on two modes of sensing for the target. The thermal sensor in the module is responsible for detecting the thermal signal from the target and the VIS/IR sensor is responsible for collecting image information of the target in some embodiment. The target image information includes body shape, body and hand gestures for commands. When the target is a human user, he/she can use predefined set of hand gestures for commanding the tracking light. If the user does not use any predefined hand or body gestures, automatic tracking mode is used in some embodiment. The sensor information can be processed on an electronic board in the track light module in some embodiment. In some embodiment, the sensor data is processed remotely in the cloud via a communication network. The processed information is converted into a command and sent to the LED module array for illumination operations in some embodiment. The Fresnel lens 503 directs light beams from LED module array to detection regions of its sensor module array. When a target such as a human user 504 is detected in a detection region, the LED module 501 responsible for the corresponding detection region is turned on in some embodiments. In a default mode, when a user is sensed in a given detection region such as his/her cubicle in an office building, the tracking light system assumes this user wants the light on. The user can overrule this decision by using predefined hand gestures or body gestures which are extracted from single band or multispectral images in some embodiment. In some embodiment, the user can also dim the light or steer the light beam slightly by using predefined body or hand gestures. A light cone 505 generated by the LED module 501 illuminates the region where the target user 504 is positioned. When the target user 504 moves into an adjacent detection region, the LED module 501 corresponding to this region is automatically activated, or turned on. The LED module 501 in the previous detection region is automatically turned off. As the target user 504 moves through various detection regions, LED modules 501 are activated and inactivated, i.e., turned on and off instantly, one by one, to follow the motion of the object of interest, e.g., user 504 ensuring high speed tracking. The illumination spot 506 formed by the intercept of the light cone 505 with illumination surface overlaps the detection region. The illumination spot can be smaller, equal, or larger than the detection region.

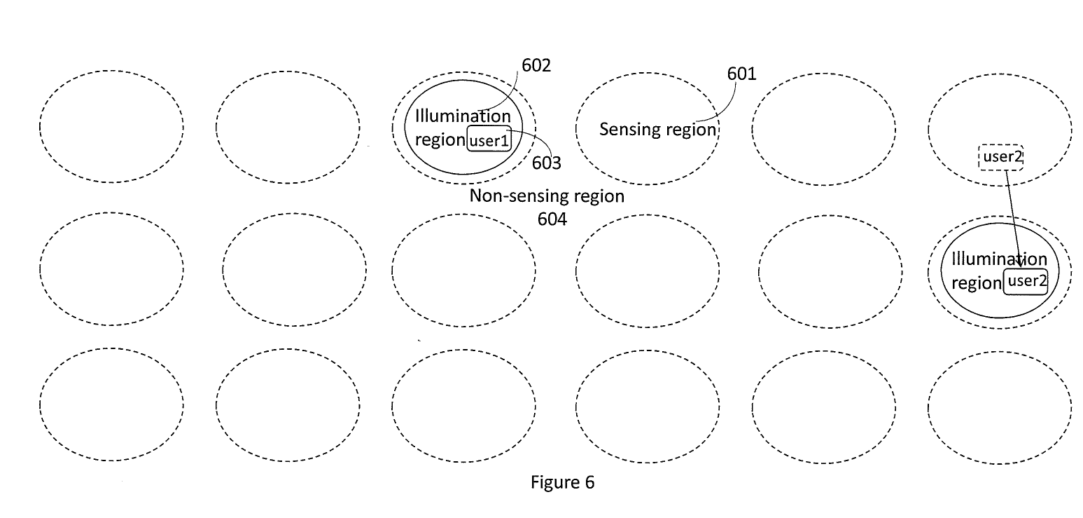

FIG. 6 continues to illustrate the concept of tracking illumination of FIG. 5. The denoted circles 601 represent sensing or detection regions. The entire area is divided into a grid of detection regions. When a user 603 is present in a detection region, the LED responsible for this detection region is activated, or turned on. An illumination spot 602 is represented in FIG. 6 as a solid circle, which may be smaller than, equal to, or greater than the detection region 601. If another user is present in another detection region 601, the LED for that region is activated, or turned on. Each sensor-LED pair can be operated independently based on the detection on its own detection region. A tracking light system contains multiple tracking light modules. Each module contains array of sensor-LED pairs. For example, a sensor module 509 and LED module may form a sensor-LED pair. Thus, in some embodiments, multiple users can access their illuminations locally at the same time. Because each sensor-LED pair is only responsible for a small region, a high resolution localized illumination can be obtained. High resolution illumination may refer to lighting control for a small area, but not limited thereto, distinguished from conventional low resolution motion sensors, which activate all lights in a room instead of activating a single light or predetermined group of lighting devices because the entire area is covered by the detection/illumination areas of arrays of sensor-LED pairs, a high resolution localized illumination is available everywhere at the same time. Multiple users can use localized illuminations in multiple places at the same time in some embodiment.

In some embodiments, each tracking light module has a LED array. An individual LED has a fixed position relative to the center of the Fresnel lens, for example, shown in FIG. 1. In some embodiments, a single moving LED can be used to move to the locations of the LED array in a tracking light module. This single moving LED has the same function as a LED array. In particular, the single moving LED can illuminate some or all the detection regions in the entire area of interest for a tracking light module. The mechanism for moving the LED can be motorized xy rails, in some embodiments, but not limited thereto. For example, other mechanisms can be used in other embodiments.

The tracking light module in the FIGS. 1-6 are based on detection and illumination at a fixed direction, for example, when a LED is placed at a fixed location relative to the center of a Fresnel lens, the direction of its output light beam is fixed, and relies on an LED array and sensor array to accomplish it. In some embodiments, a steerable sensor and a steerable light mechanism can be used to form a steerable tracking light module. One example of a steerable light mechanism is described in patent PCT/US2015/028163, incorporated by reference herein in its entirety. In some embodiments, a steerable sensor is a sensor with a beam steering mechanism. A beam steering mechanism such as a gimbal, MEMS mirror, Risley prism pair, steerable Fresnel lens can be used to guide the FOV of the sensor toward the target in some embodiments. In some embodiments, a steerable tracking light system comprising steerable tracking light modules formed by a plurality of steerable lights and steerable sensors can be installed on a ceiling or other surface similar to the arrangement in FIG. 5 to track targets. Each tracking light module tracks the movement of the target and provide steerable light beam to follow the target within its tracking range in some embodiment. When the target enters the tracking range of its neighbor tracking light module, this neighbor will track and steer light beam to follow the target. The light beam in the previous tracking light is inactivated, or turned off. As the target moves through space, tracking light modules continuously track and provide steerable light beam to follow the target in some embodiments.

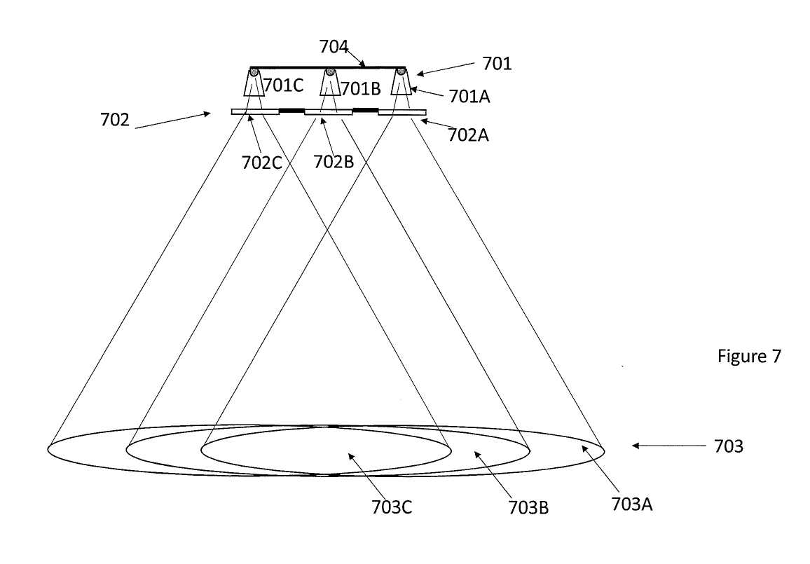

FIG. 7 is the beam pattern 703 generated from a lens array 702 over a LED array 701 assembly. Each LED in the LED array 701 has its own lens in the lens array 702 in some embodiments. In some embodiments, the lens array 702 can be a Fresnel lens array. In some embodiments, the Fresnel lens array 702 can be a cylindrical lens array. In some embodiments, the lens array 702 can includes other types of lenses, e.g., a lens other than a Fresnel lens. In some embodiments, the LED array 701 can be a linear type, for example, and can comprise a plurality of linear LED strips. A corresponding Fresnel lens array 702 can comprise a plurality of cylindrical Fresnel lens array in some embodiments. Each LED-lens pair 701, 702 projects an illumination spot onto the illumination surface. The resulting beam pattern 703 is an aggregate or combination of illumination spots from all LED-lens pairs 701, 702 in the lens-LED array assembly. The LED array element 701A and the Fresnel lens array element 702A creates illumination spot 703A at the illumination surface. The illumination spots almost fall on top of each other. The non-overlapping is result of relative distances between a given LED and all other LEDs in the LED array. The intensity in the overlapping area is the sum intensities from all LEDs.

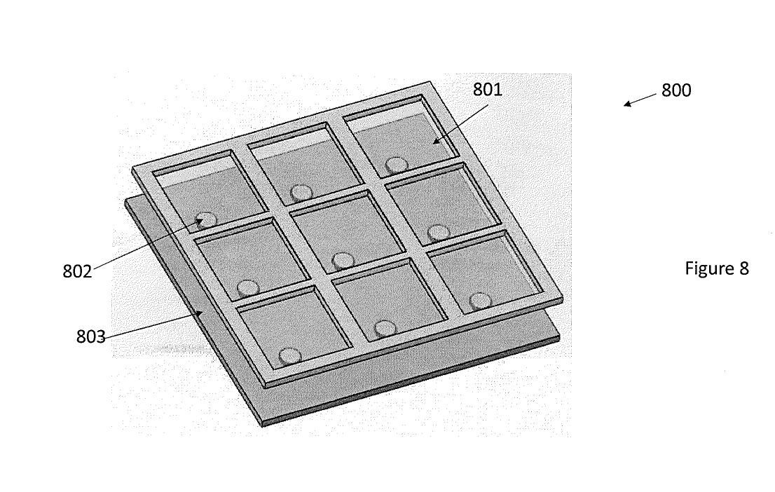

FIG. 8 illustrates front view of a LED-lens assembly 800, for example, a front view of FIG. 7. This is what it looks like this if we are looking at the assembly from below the assembly in FIG. 7. It can comprise a lens array 801, a LED array 802 mounted to a heatsink 803 in some embodiment. Each LED in the LED array pairs with a lens from the lens array.

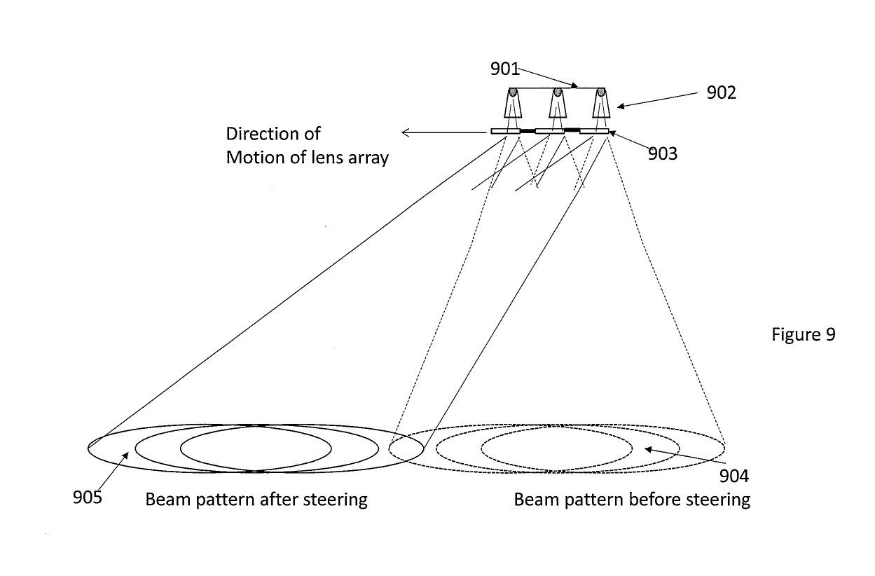

In some embodiments, an illumination beam pattern 703 formed by the LED-lens assembly/module 800 can be steered by translating the lens array 801 in a plane parallel to the LED array 802, for example, illustrated in FIG. 9. Here, a lens array 903 moves relative to the LED array 902 mounted on the heatsink 901. The illumination beam pattern moves from position 904 to 905 in response to the lens movement.

In some embodiments, as shown in FIG. 10, a Fresnel lens array 1002 can be placed on a xy planar motion platform 1007 and moved relative to an LED array 1001. The dotted circle array 1001 is the LED array. The square array 1002 is the Fresnel lens array. The LED array is behind the lens array held stationary. The Fresnel lens array 1002 can be on an electromagnetic motion platform comprising of an inner frame 1006, an outer frame 1007, which are held together by a set of suspension flexures 1005 or the like. Four magnets 1004 are mounted on the inner frame 1006 while four electromagnetic coils 1003 are mounted on the outer frame 1007. The Fresnel lens array 1002 is mounted on the inner frame 1006. The inner frame 1006 is moved by the magnetic force generated by the interaction between magnets 1004 and electromagnetic coils 1003. The illumination beam moves as result of the Fresnel lens movement. In some embodiments, there are four pairs of magnet-electromagnetic coil mounted on the inner 1006 and outer 1007 frames. The amount of motion is controlled by the input current to the electromagnetic coils. In some embodiments, the illumination beam can be steered by moving the LED array while holding the Fresnel lens stationary. The electromagnetic motion platform of FIG. 10 has fast response time and can be made to any size. This is useful for fast applications.

In some embodiments, the motion platform of 1000 in FIG. 10 or 1002A which including the Fresnel lens array 1004A in FIG. 10A can be placed on a motorized vertical rail system 1003A to move the lens array toward or away from the LED array 1001A as illustrated in FIG. 10A. This allow users to adjust the output light beam size.

In some embodiments, the motion platform of 1000 in FIG. 10 or 1002B in FIG. 10B can be placed on an electromagnetic rail system comprising 4 vertical rails 1003B, 4 magnets 1004B mounted on the motion platform 1002B, 4 electromagnetic coils 1005B on the vertical rails 1003B as illustrated in FIG. 10B. The Fresnel lens array 1006B is placed on a motion platform 1002B. By moving the Fresnel array toward or away from the LED array 1001B, the output light beam size can be adjusted, for example, increased, decreased, moved, and so on.

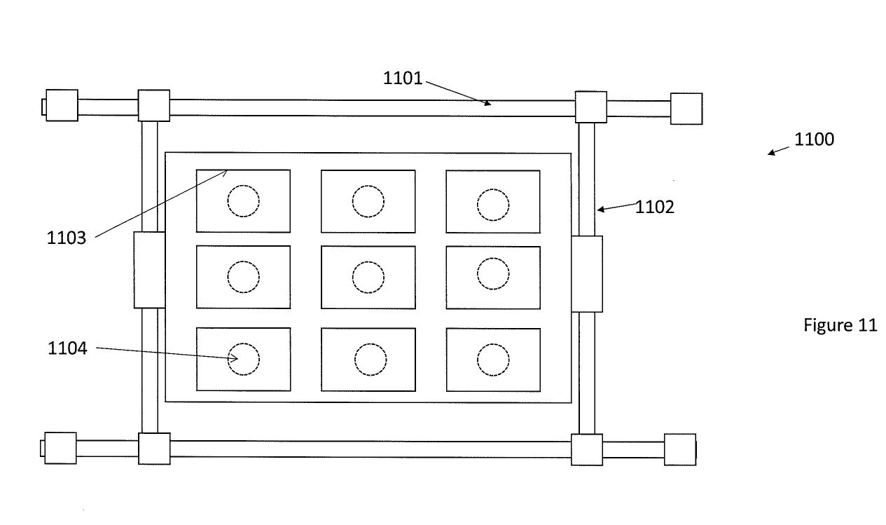

In some embodiments, as shown in FIG. 11, a Fresnel lens array 1103, which may be similar to other Fresnel lens arrays described herein, can be placed on a xy motorized rail motion platform 1101, 1102 with the LED array 1104 holding stationary. The dotted circle array is the LED array 1004. The square array is the Fresnel lens array. The LED array is placed behind the lens array. The xy motorized rail motion platform can comprises of a pair of inner rails 1102 and a pair of outer rails 1101. The illumination beam is steered by moving Fresnel lens array in the xy rail motion platform. In some embodiments, a beam steering operation of the illumination beam can be obtained by placing the LED array on the motion platform and move the LED array while keeping the Fresnel lens 1103 stationary. In some embodiments, the xy motion platform 1100 can be placed on a motorized vertical rail system, for example, shown in FIG. 10A for beam size adjustment. By moving the lens array 1103 toward or away from the LED array, the light beam size can be adjusted.

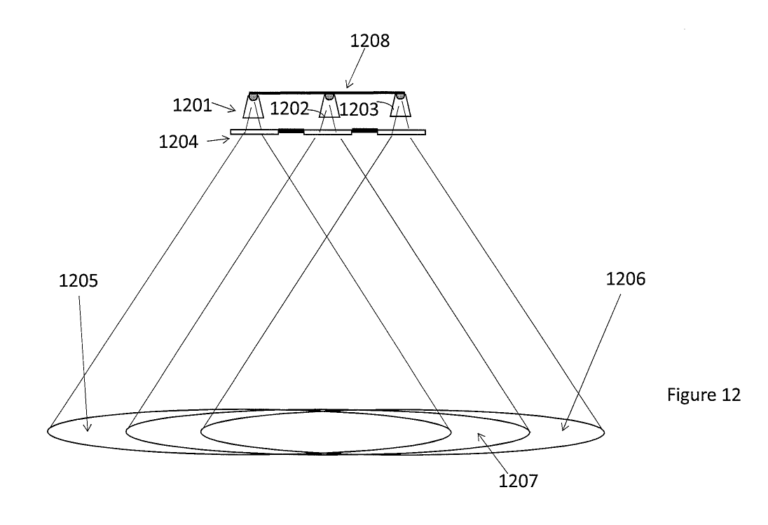

In some embodiments, a red, green, and blue (RGB) LED array 1208 can be used to replace the LED array in FIGS. 7, 8, and 9 for performing a steerable color mixing as illustrated in FIG. 12. Color mixing occurs for any given adjacent RGB LEDs 1201, 1202, and 1203 in the array in some embodiments. Their output beams 1205, 1206, and 1207 at the illumination surface fall on top of each other to create a new color beam in the overlap region. Various colors can be created by varying the inputs to the three color LEDs. Because the offset distance among these 3 LEDs, there are non-overlapping regions. The RGB LED array can comprise groups of adjacent RGB LEDs to create color light at various regions in the illumination surface in some embodiment. The resulting color beam can be steered by moving the Fresnel lens array 1204. In some embodiments, the Fresnel lens array is positioned on a motion platforms described in FIG. 10 or FIG. 11.

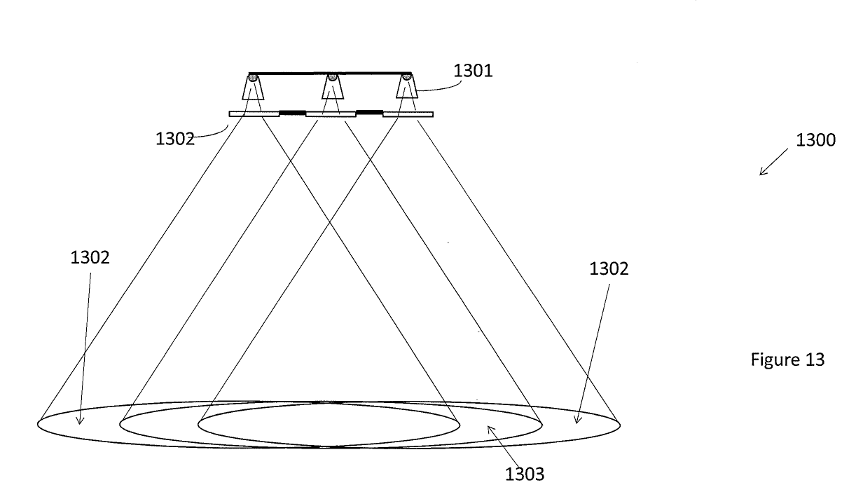

In some embodiments, an LED array comprising a combination of visible LEDs and LiFi communication light sources 1301 may replace the LED array in FIGS. 7, 8, and 9 as illustrated in FIG. 13. This allows the illumination beams 1302 and communication beam 1303 in FIG. 13 to overlap. By moving a Fresnel lens array using the mechanisms described in FIGS. 10 and 11, the combined beam may be moved in the illumination surface. In some embodiments, the visible illumination light can be used for LiFi communications. In some embodiments, an IR light source is used for LiFi communications while visible light source is used for illumination.

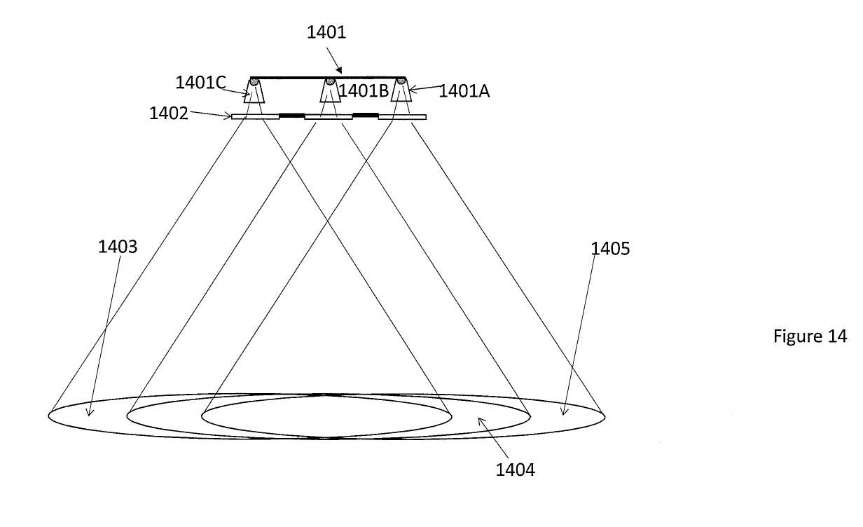

In some embodiments, an LED array 1401 comprising groups of color temperature triad LEDs, warm 1401C, neutral 1401B, and cool 1401A may replace the LED array in FIGS. 7, 8, and 9 as illustrated in FIG. 14. The output beams through the lens array from the different color temperature LEDs, e.g., warm 1403, neutral 1404, and cool 1405, fall on top of each other, and therefore may overlap. Color temperature tuning can be obtained by adjusting the inputs to various LEDS in some embodiment. For example, if a warmer light is needed, the input to the warm LED should increases while the input to the cool LED should decrease. The resulted color tuned light beam can be steered by moving the LED array 1401 using the mechanisms described in FIGS. 10 and 11. Color mixing and color temperature tuning shown in FIG. 12 and FIG. 14 may have non-overlapping regions due to offsets among the LEDs of the LED array 1401 (FIG. 14) or LED array 1208.

The range of beam steering in accordance with some embodiments is limited by the size of individual Fresnel lenses in the Fresnel lens array. In some embodiments, a 3-face pyramid mirror and a lens can be used to perform a color mixing and color temperature tuning operation. Three LEDs can be placed at three separate foci, respectively, of the lens. FIG. 15A is a sideview drawing of assembly. RGB LEDs 1503A, 1504A, are placed at the foci 1505A of the lens 1501A. A green LED is not shown in the figure. The 3-face pyramid mirror 1502A has 3 mirror surfaces positioned at 45° angles relative to the base of the pyramid mirror. The light emitted from the LEDs is reflected by the pyramid mirror 1502A and collimated by the lens 1501A. Because the light beams from the three LEDs are collimated by the same lens 1501A, the output light beams coincide completely in space to form a single beam. The input currents to the RGB LEDs vary, a new color can be obtained in some embodiment.

FIG. 15B is a top view drawing of the assembly. As shown in FIG. 15B, the RGB LEDs 1502B, 1503B, and 1504B are placed at the foci of the lens (not shown). Light beams emitted by the RGB LEDs are reflected by the 3-face pyramid mirror and collimated and mixed by a common lens, for example, lens 1501A of FIG. 15A. By moving the lens 1501A, the output color beam can be steered in some embodiments. This allows a user to access color mixing light from any location. In some embodiments, the lens can be a Fresnel lens. In some embodiments, the lens can be other type of lens. A beam steering mechanism may be used to perform a beam steering operation, and can include motorized linear rails, for example, shown in FIG. 11. For example, the three LEDs 1502B, 1503B, and 1504B and 3-face pyramid mirror assembly 1502A can be placed on a vertical rail for beam size adjustment in some embodiment.

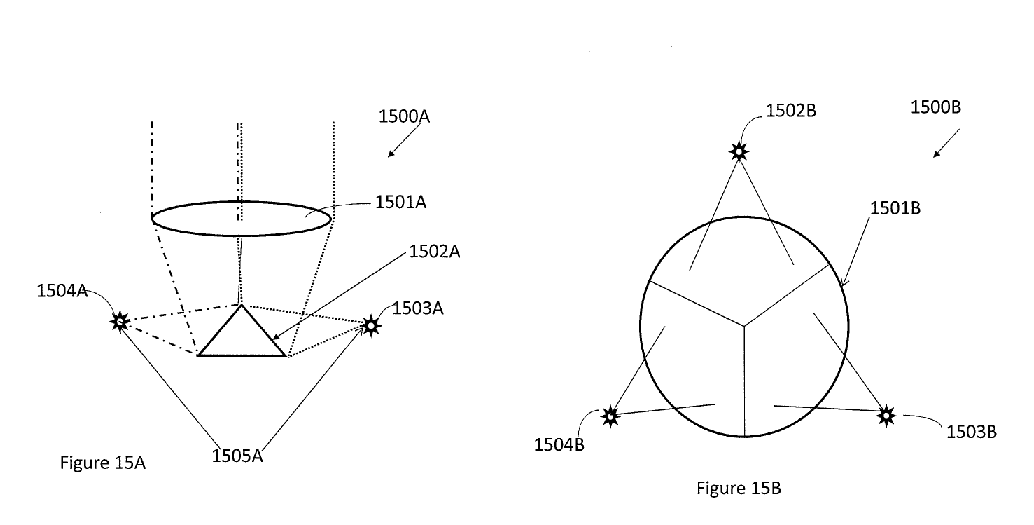

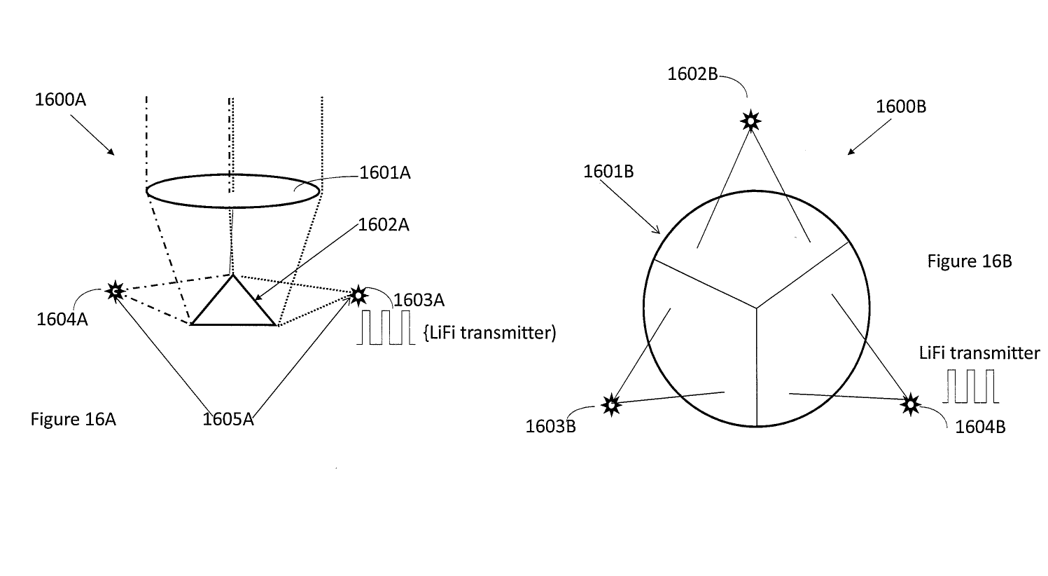

In some embodiments, the RGB color LEDs in FIG. 15 can be replaced by two visible LEDs 1604A and LiFi communications LED 1603A as illustrated in FIG. 16. The emitted LED light beams reflected by the 3-face pyramid mirror 1602A are collimated by a lens 1601A, which may be similar to or the same as other lenses described herein. The output beams coincide in space. Thus the combined output beam contains both LiFi communications signal and visible light for illumination. In some embodiments, the spectral band of the LiFi communication LED is the same as that of the visible LED. In some embodiments, the spectral band of the LiFi communication LED is not the same as that the visible, NIR for example.

FIG. 16B is a top view drawing of an assembly, in accordance with some embodiments, which may include two visible LEDs 1602B, 1603B, and a LiFi communication LED 1604B. In some embodiments, the combined output light beam can be steered by moving the lens laterally relative to the pyramid mirror 1602A. This allows the user to access illumination and LiFi communication at the same time anywhere. In some embodiments, the lens can be a Fresnel lens. In some embodiments, the lens can be other type. In some embodiments, the beam steering mechanism can be the same as that described in FIG. 11. The three LEDs and 3-face pyramid mirror assembly can be placed on a vertical rail for beam size adjustment in some embodiments, for example, illustrated herein.

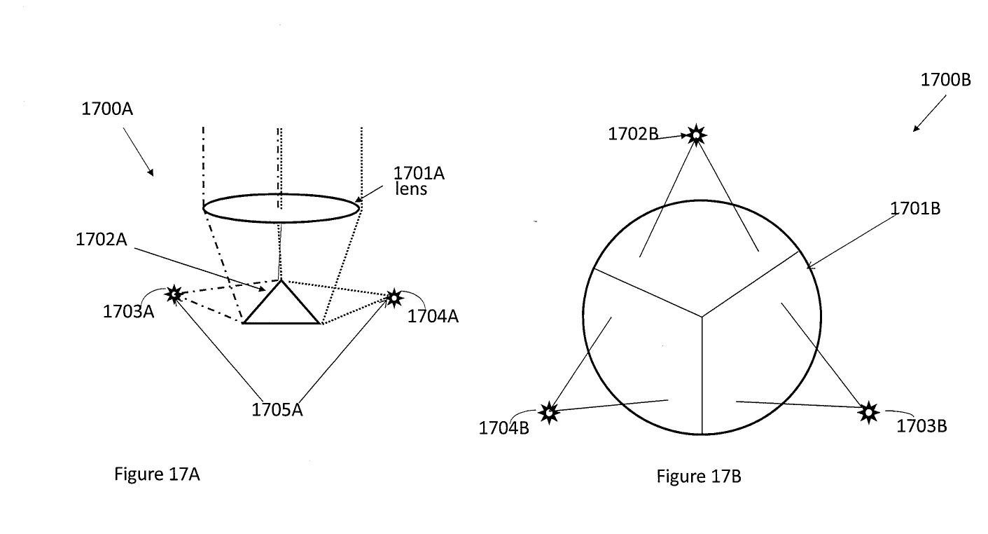

In some embodiments, the RGB color LEDs in FIG. 15 can be replaced by warm 1702A, neutral (not shown), and cool 1703A LEDs as illustrated in FIG. 17A. Three color temperature LEDs are placed at foci 1705A of the lens, which may be the same as or similar to LEDs 1702B, 1703B, and 1704B in FIG. 17B. The emitted LED light beams reflected by the 3-face pyramid mirror 1702A are collimated by the lens 1701A. The output light beams coincide completely. The color temperature of the output light beam can be adjusted by varying the inputs to the three LEDs in some embodiments. Warmer light requires the increasing input current of the warm LED while decreasing the input current to the cool LED.

FIG. 17B is a top view of the assembly of FIG. 17A. The three color temperature LEDs 1702B, 1703B, and 1704B are placed at the foci of the lens. Emitted light beams from the three LEDs are reflected by the 3-face pyramid mirror 1701B and collimated by the lens (not shown). In some embodiments, the color temperature adjusted light beam can be steered by moving the lens 1701A. In some embodiments, the lens can be a Fresnel lens. In some embodiments, it can be any other type. The lens can be placed on a beam steering mechanism described in FIG. 11. The three LEDs and 3-face pyramid mirror assembly can be placed on a vertical rail for beam size adjustment in some embodiments.

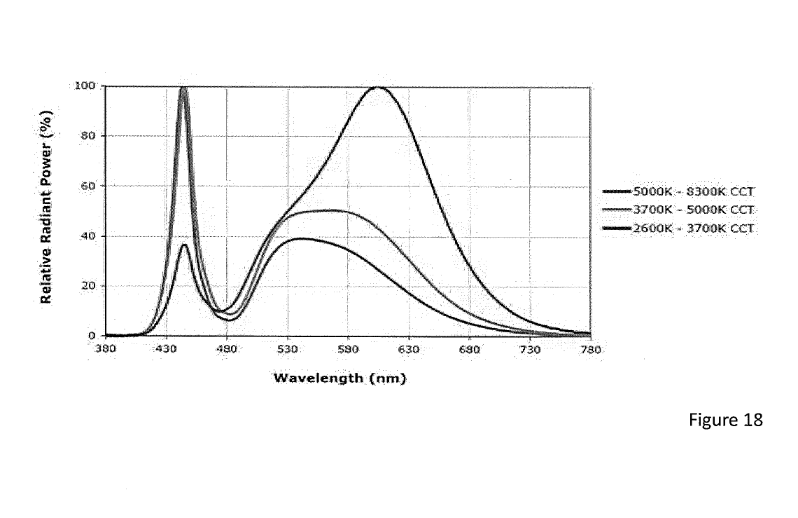

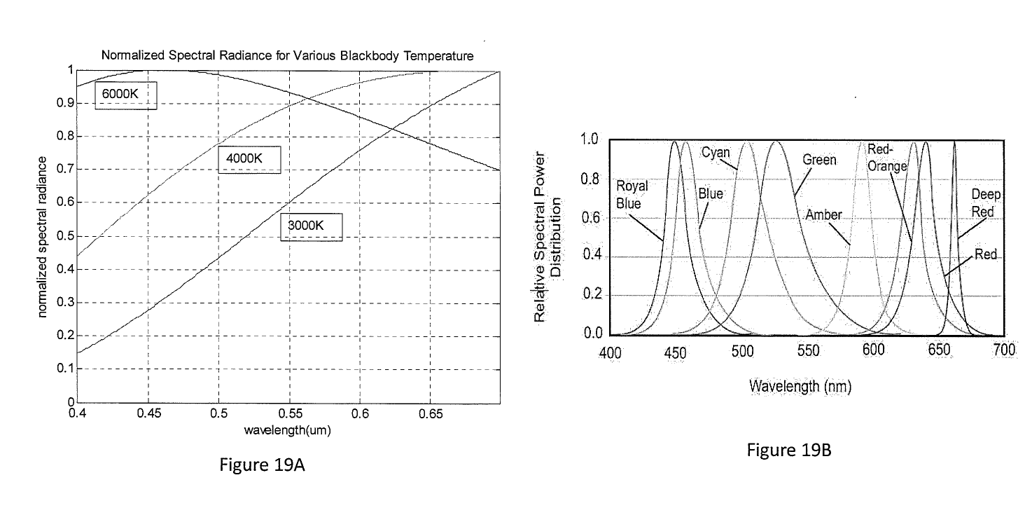

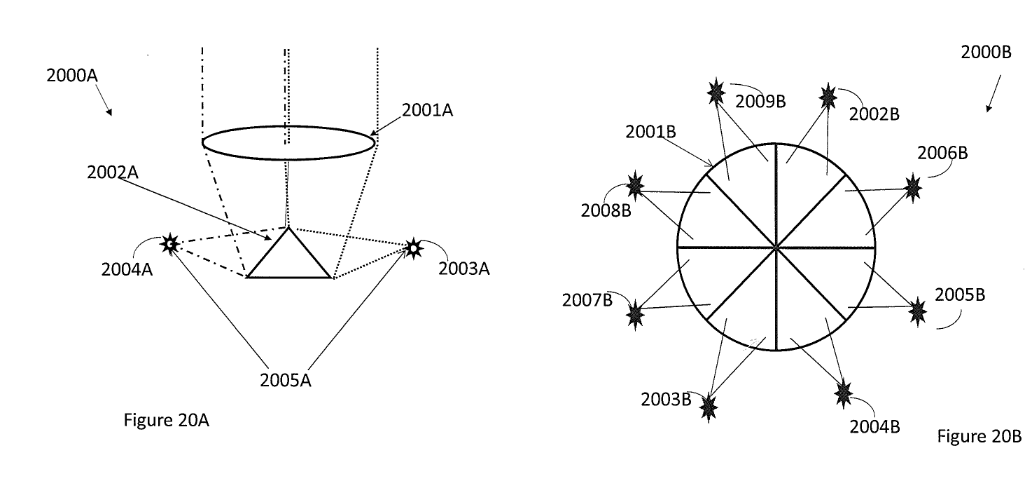

FIG. 18 shows the spectral curves of white LEDs at 3 different color temperatures ranges for warm, neutral, and cool color temperatures. FIG. 19A shows blackbody spectral curves at 3 different temperatures, 3000K, 4000K, and 6000K corresponding to warm, neutral, and cool color temperatures. These black spectral curves are very different than the white LED spectral curves at the warm, neutral, and cool color temperatures. FIG. 19B illustrates the spectral curves for various color LEDs. The graphs in FIGS. 18, 19A, and/or 19B may be produced using one or more apparatuses in FIGS. 1-17, but not limited thereto. To match the blackbody spectral curves, it is preferable to use color LEDs by adjusting or tuning their input currents such that the combined spectral curves match the blackbody spectral curves at various color temperatures in some embodiments. These color LEDs can be placed at the foci of a lens such that their output beams coincide in space in some embodiment. A multi-facet pyramid mirror, for example, mirror 2002 shown in FIG. 20A, can be placed on the beam path of the lens 2001A to produce multiple foci as illustrated in FIGS. 20A and 20B.

In particular, FIG. 20A is a sideview drawing of the color LEDs-mirror-lens assembly 2000A. The color LEDs 2003A and 2004A (others not shown) are placed at the foci 2005A of the lens 2001A. A multi-facet pyramid mirror 2002A is placed on the focusing beam path of the lens 2001A to produce multiple foci 2005A. The output beams of all the color LEDs are collimated and coincide in space. FIG. 20B is a top view drawing of the optical assembly 2000B. Color LEDs 2002B to 2009B are placed at the foci of the lens 2001A of FIG. 20A. The foci can be produced by inserting the multi-facet mirror 2001B in the focusing path of the lens. Using this optical assembly, a user can produce light beam at any color temperature whose spectral curve matches well with the spectral curve of a blackbody at the color temperature by adjusting inputs to various color LEDs. By placing the LED-pyramid mirror assembly on a xy rail assembly described in FIG. 11, a user can steer the output light beam of the system by moving the assembly relative to the lens in some embodiment. The LED and multi-facet pyramid mirror assembly can be placed on a vertical rail (see FIG. 10A) for beam size adjustment in some embodiments.

In the beam steering mechanism and beam size adjustment mentioned above and in Patent PCT/US2015/028163 incorporated by reference herein in its entirety, the focal length of the lens is fixed. In some embodiments, two lenses can be used to produce a lens with adjustable focal length.

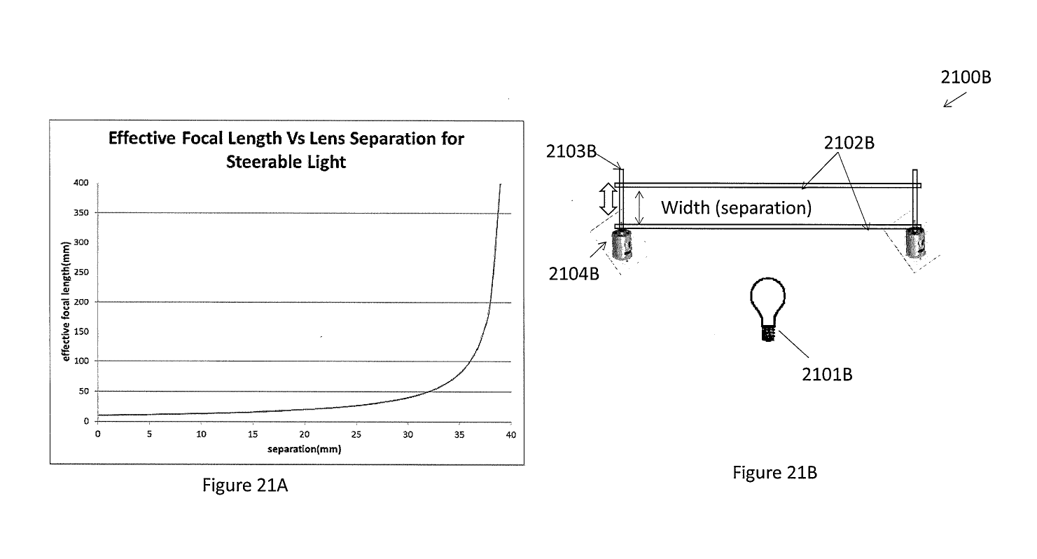

The effective focal length of a 2-lens system is given by

$${f}_{eff} = \frac{{f}_{1} {f}_{2}}{{f}_{1} + {f}_{2} - d} .$$

Where f₁ and f₂ are focal lengths of the two lenses. d is the separation distance between the twolenses. If the two focal lengths are the same, the effective focal length is half the original focal length. It becomes infinity when the separation is approaching 2 times the focal length. FIG. 21B illustrates this concept. Here, a light source 2101B is placed behind a 2-lens system 2102B. The two lenses are placed on a motorized rail system which can adjust the separation between the two lenses 2102B. The motorized rail system can comprise one or multiple motors 2104B and rails 2103B.

FIG. 21A is a simulation of the effective focal length for a dual-lens system with 20 mm focal length for various lens separation. The effective focal length increases slowly in the beginning and quickly after 30 mm which is close to 2 focal lengths but not limited thereto. In some embodiment, a focal length adjustable lens system described in FIG. 21B can be employed to do beam steering and beam size adjustment at various focal length described in this patent and in patent number PCT/US2015/028163 incorporated by reference herein in its entirety.

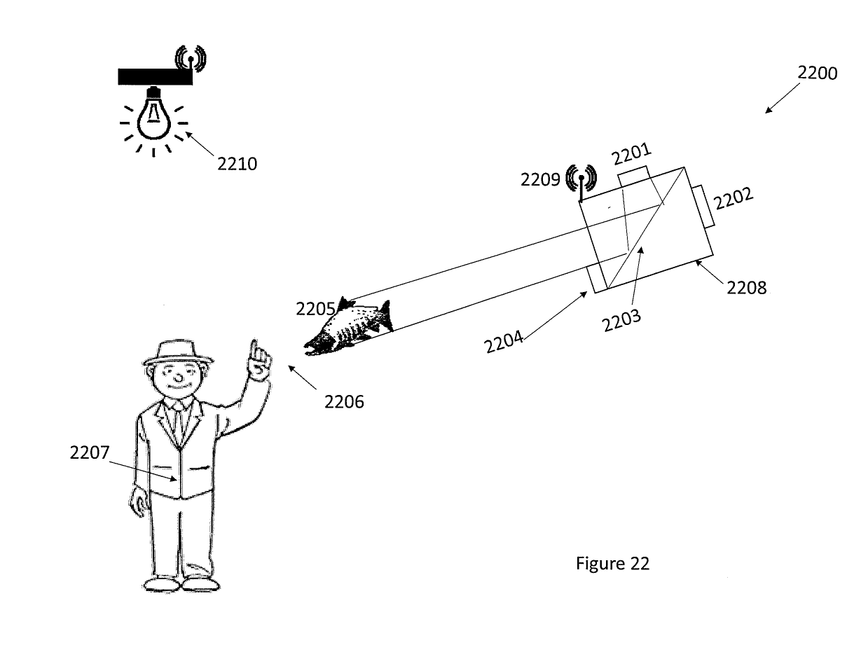

In some embodiments, as shown in FIG. 22, a holographic controller 2200 can be used to control lighting, equipment and other devices. In some embodiments, the holographic controller 2200 can comprise of a holographic projector 2202, a camera 2201, a beamspliter 2203, a thermal sensor 2204, a wireless communication device 2209 and a housing 2208.

The beamsplitter 2003 reflects the holographic image and transmits image light of the camera 2201. This geometry ensures that the LOS of the holographic projector 2202 and the LOS of the camera 2201 are aligned. Components 2202, 2201, 2203, 2209, and 2204 may be mounted on the housing 2208. The housing 2208 in turn may be mounted to a gimbal or the like, for example, described in FIG. 4A for placing the holographic image and in the LOS the user 2207. The gimbal is not shown in FIG. 22.

In some embodiments, the thermal sensor 2204 can be radiometricly calibrated that can measure temperature of the user. In operation, the thermal sensor 2204 senses the presence of a human user 2207. It directs the gimbal to move such that the user is in the FOV of the camera 2202. In some embodiment, the projector 2202 projects a holographic image 2205 onto a beamsplitter 2203. The beamsplitter 2203 redirects the image along the LOS of the user 2007. When the user sees the holographic image, he/she can place his/her hand gestures 2206 in that direction in some embodiments.

In some embodiments, the camera 2202 behind the beamsplitter 2203 will capture an image of the hand gestures 2206 and send them to a processor in an electronic board on the controller (not shown) or to the cloud computing environment or the like via the wireless network 2209 for processing. The processed images will be converted into commands the user wants to control a device 2210 remotely in some embodiments. The holographic image 2205 allows the user 2207 to identify the LOS and FOV of the camera 2203 and the thermal sensor easily as compared to previous conventional techniques. The LOS of the camera 2201 and the LOS of the holographic projector are preferably aligned. When the user 2207 place his/her hand gestures 2206 at the holographic image 2205, he/she mostly likely intends to send commands to control the device 2210. The camera also has the best view of the hand gestures. The radiometrically calibrated thermal sensor 2204 can confirm whether the hand or other body parts belong to a human by measuring their temperatures. This ensures that the hand gestures are real hand gestures.

It is to be understood that the foregoing description is intended to illustrate and not to limit the scope of the invention, which is defined by the scope of the appended claims. Other embodiments are within the scope of the following claims.

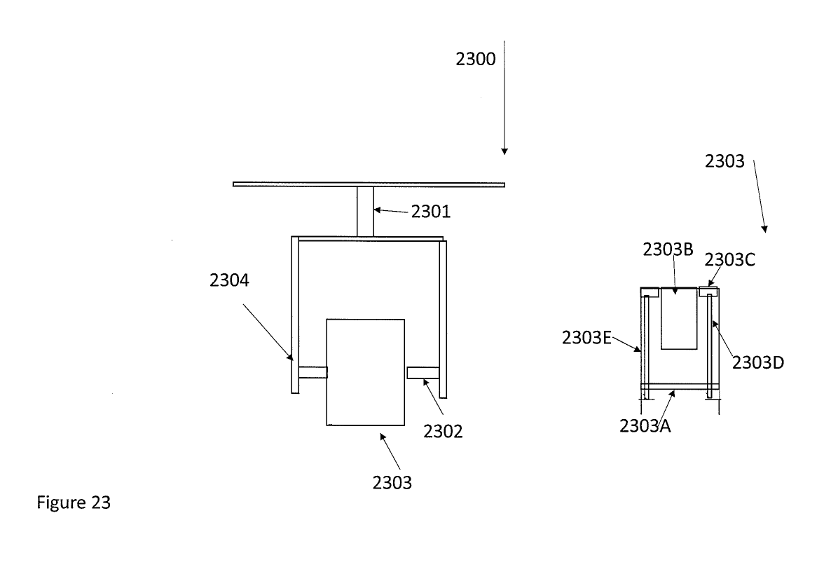

Conventional beam steering mechanism employs a gimbal to steer the light beam. A light source is mounted on the gimbal. It does not have a beam size adjustment capability. In some embodiment, as illustrated in FIG. 23, a lens such as Fresnel lens 2303A and motorized rails comprising motors 2303C with lead screws 2303D can be used to adjust the output light beam size. The beam size is adjusted by moving the lens toward or away from the light source 2303B. The components 2303A, 2303B, 2303C, and 2303D can be mounted in the housing 2303E. The light source assembly 2303 can be mounted to a gimbal 2300 which includes a housing 2304, a pitch axis 2301, and a roll axis 2302. The gimbal allows steering of the output light beam. The system in some embodiments allows the user to steer light beam and adjust its size at the same time.

1. A tracking light system that tracks one or more targets and provides an illumination region locally at the one or more targets, comprising:
a tracking light module, comprising:
a sensor module array comprising a plurality of sensor modules, each sensor module comprising at least one sensor;
a light emitting diode (LED) module array comprising a plurality of LED modules; and
a lens in front of the LED module array, wherein an LED of an LED module of the LED module array outputs a source of light directed at the lens and forming a projection spot on a surface of an area of interest, the at least one sensor forming a detection region that overlaps the projection spot for monitoring the projection spot, wherein when an object is detected in the detection region, the LED is activated to output the source of light, and wherein when the object departs the detection region, the LED is turned off.

2.-20. (canceled)

21. The tracking light system of claim 1, wherein the object is a target user.

22. The tracking light system of claim 1, wherein the at least one sensor of the at least one sensor module comprises an emissive thermal sensor and a single band or multispectral reflective sensor.

23. The tracking light system of claim 1, wherein the sensor module comprises a thermal sensor, a visible/IR sensor, and a beamsplitter, wherein the thermal sensor senses thermal signal from the object, the visible/IR sensor uses the target reflected light from the visible and IR LEDs for single band monochromatic imaging or multiband for multispectral imaging, the thermal sensor uses thermal signal to detect the object, the visible/IR sensor uses color, motion, and a human feature.

24. The tracking light system of claim 1, wherein the LED of the LED module comprises a visible light LED, IR light LED, and a hot mirror that provides visible light for illumination of the projection spot, IR light, and visible light for multispectral or monochromatic imaging.

25. The tracking light system of claim 1, further comprising a beam steering mechanisms for steering the sensor to direct a field of view (FOV) of the sensor.

26. The tracking light system of claim 25, wherein the beam steering mechanism includes at least one of a gimbal, MEMS mirrors, Risley prism pair, or moving lens.

27. The tracking light system of claim 1, wherein the LED module array includes a moving LED module that moves to the positions of the LED modules of the LED module array in the tracking light module, for target tracking illumination.

28. The tracking light system of claim 1, wherein the tracking light modules are steerable for continuously tracking the object and steering the output source of light to follow the object.

29. A light beam steering and light beam size adjustment lighting device, comprising:
a lens array;
a light emitting diode (LED) array; and
a motion platform, wherein the lens array is place directly in front of the LED array such that each individual LED of the LED array faces one lens of the lens array to produce an overlapping light beam having an intensity that is the sum intensities from all LEDs in the LED array.

30. The light beam steering and light beam size adjustment lighting device of claim 29, wherein either the LED array or the lens array is positioned on the motion platform to produce a relative planar motion for steering the output the light beam.

31. The light beam steering and light beam size adjustment lighting device of claim 29, further comprising a set of motorized vertical rails to move the motion platform such that the lens array and LED array moves toward or away from each other for adjusting the size of the output light beam.

32. The light beam steering and light beam size adjustment lighting device of claim 31, wherein the motion platform is an electromagnetic type describe or a motorized rail type.

33. The light beam steering and light beam size adjustment lighting device of claim 29, wherein the lighting device is operable for a light beam steerable, light beam size adjustable, color mixing lighting device, wherein the LED array includes a color LED array comprising groups of RGB LEDs.

34. The light beam steering and light beam size adjustment lighting device of claim 29, wherein the lighting device is operable for a light beam steerable, light beam size adjustable, LiFi communication and illumination lighting, wherein the LED array includes a LiFi communication light source and visible LEDs for illumination.

35. The light beam steering and light beam size adjustment lighting device of claim 29, wherein the lighting device is operable for a light beam steerable, light beam size adjustable, color temperature tunable lighting device, wherein the LED array includes groups of LEDs with warm, neutral, and cool color temperatures.

36. A LED color light mixing optical system with beam steering and beam size adjustment capability, comprising:
a lens;
a 3-face pyramid mirror; and
three color LEDs at a foci of the lens to produce a color light beam fully overlapping in space, wherein the 3-face pyramid mirror is at the focusing beam path of the lens to produce three foci for placing the RGB LEDs, wherein the input currents of the RGB LEDs are adjusted to produce various color light beams.

37. The LED color light mixing optical system of claim 36, further comprising a motion platform that moves the lens laterally respect to the pyramid mirror and RGB LEDs for steering the output color light beam, the motion platform that moves the lens toward or away from the pyramid mirror and LEDs to change the size of the output color light beam.

38. The LED color light mixing optical system of claim 36, for producing a steerable, beam size adjustable, light beam for both illumination and LiFi communications by replacing the RGB LEDs by LiFi communication and visible LEDs.

39. The LED color light mixing optical system of claim 36, for producing a steerable, beam size adjustable, color temperature adjustable light beam by replacing the RGB LEDs with LEDs at warm, neutral, and cool color temperatures.
